(19) United States
(12) Patent Application Publication
(10) Pub. No.: US 2026/0009196 A1
(43) Pub. Date: Jan. 8, 2026

(54) Oil Removal Device

(71) Applicants: YU-RU LIU, Taipei City (TW); KANG-YAN LIU, Taipei City (TW)

(72) Inventors: YU-RU LIU, Taipei City (TW); KANG-YAN LIU, Taipei City (TW)

(21) Appl. No.: 18/813,610

(22) Filed: Aug. 23, 2024

(30) Foreign Application Priority Data
Jul. 5, 2024 (TW) 113125335

(51) Int. Cl. E02B 15/04; B01D 17/02; B01D 17/12; C02F 1/00; C02F 1/40; C02F 101/32; C02F 103/08

(52) U.S. Cl. CPC E02B 15/045; B01D 17/0211; B01D 17/0214; B01D 17/12; C02F 1/008; C02F 1/40; C02F 2101/32; C02F 2103/08; C02F 2201/005; C02F 2201/008; C02F 2209/008; C02F 2209/42

(57) ABSTRACT

An oil removal device includes a treatment tank and a storage tank. The treatment tank includes a body and a floating member. The body includes a shaft receiving hole receiving a shaft of the floating member and permitting axial movement of the shaft. The treatment tank includes a chamber intercommunicating with the shaft receiving hole. The chamber includes a liquid inlet hole, an oil drain hole, and at least one water drain hole. The storage tank includes a storage space intercommunicating with the oil drain hole of the treatment tank. The storage tank is provided with a control module coupled with a liquid level sensor and a locating unit. The liquid level sensor detects an amount of oil stored in the storage space and to generate an oil quantity information transmitted back to the control module. The locating unit generates a location coordinate sent back to the control module.

### CROSS REFERENCE TO RELATED APPLICATION

The application claims the benefit of Taiwan application serial No. 113125335, filed on Jul. 5, 2024, and the entire contents of which are incorporated herein by reference.

### BACKGROUND OF THE INVENTION

### 1. Field of the Invention

The present invention relates to an oil removal device and, more particularly, to an oil removal device for filtering floating oil.

### 2. Description of the Related Art

With industrialized massive oil exploitation and oil spill incidents of oil tankers, oil floats on the sea surface and spreads quickly along with the ocean current, resulting in tremendous impact on the marine ecosystem and economy.

Conventional oil cleaning methods for massive oil spill incidents generally includes adsorption and suction approaches. The adsorption approach includes using ropes to encircle the floating oil in a predetermined area. Then, adsorbing objects on which oil may adsorb, such as brushes and cottons, are placed into the encircled floating oil. After the floating oil is adsorbed on the adsorbing objects, the adsorbing objects are removed, and the adsorbed oil is collected through scratching or squeezing. The suction approach includes using a liquid suction device, such as a pump, to suck the floating oil and the seawater into a treatment tank. Then, the floating oil and the seawater are separated through use of chemicals and based on the different densities of the floating oil and the seawater. Next, the floating oil is recovered.

However, the floating oil may have rapidly spread along with the ocean current before the above oil recovery method is used. Alternatively, occasional or unknown small-quantity oil spill incidents may result in long-term floating of oil on the sea surface and spread in all directions along with the ocean currents. All of which causes adverse influence on the marine ecosystem.

Thus, it is necessary to improve the conventional oil removing methods.

### SUMMARY OF THE INVENTION

To solve the above problem, it is an objective of the present invention to provide an oil removal device which may collect the floating oil floating on the sea surface to avoid spreading of the floating oil, thereby reducing impact on the marine ecology.

It is another objective of the present invention to provide an oil removal device which may transmit a signal to notify management personnel for subsequent handling purposes when a predetermined amount of oil is collected.

As used herein, the term “engagement”, “coupling”, “assembly”, or similar terms is used to include separation of connected members without destroying the members after connection or inseparable connection of the members after connection. A person having ordinary skill in the art would be able to select according to desired demands in the material or assembly of the members to be connected.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

An oil removal device according to the present invention includes a treatment tank and a storage tank. The treatment tank includes a body and a floating member. The body includes a shaft receiving hole receiving a shaft of the floating member and permitting axial movement of the shaft. The treatment tank includes a chamber intercommunicating with the shaft receiving hole. The chamber includes a liquid inlet hole, an oil drain hole, and at least one water drain hole. The storage tank includes a storage space intercommunicating with the oil drain hole of the treatment tank. The storage tank is provided with a control module coupled with a liquid level sensor and a locating unit. The liquid level sensor is configured to detect an amount of oil stored in the storage space and to generate an oil quantity information which is transmitted back to the control module. The locating unit is configured to generate a location coordinate which is sent back to the control module.

Therefore, the oil removal devices according to the present invention may be disposed widely on the sea to widely collect the floating oil floating on the sea. Furthermore, the treatment tank may fully use the energy of the sea waves to separate the oil from the seawater in the treatment tank, and the separated oil may be delivered to and stored in the storage space of the storage tank. The control module may determine whether the oil stored in the storage space reaches a predetermined amount according to the oil quantity information. If yes, the control module sends out a signal including the location coordinate to a manager, and the manager may head to the location coordinate to retrieve the storage tank. Accordingly, the floating oil floating on the sea surface may be collected to avoid spreading of the floating oil, thereby reducing impact on the marine ecosystem.

In an example, the floating member includes an air chamber and a bottom face having an area greater than an area of a top face of the body. This enables the wave to always push the bottom face, thereby permitting the floating member to move axially relative to the body.

In an example, the bottom face is conic and has a periphery higher than a top portion of the shaft. This enables the wave to always push the bottom face, thereby permitting the floating member to move axially relative to the body.

In an example, the oil drain hole is in a position higher than the liquid inlet hole, and the at least one water drain hole is in a position lower than the liquid inlet hole. Thus, the floating oil may be drained via the oil drain hole, and the seawater may be drained via the at least one water drain hole.

In an example, each of the liquid inlet hole, the oil drain hole, and the at least one water drain hole is provided with a one-way valve. When a pressure in the chamber is lower than a pressure outside of the treatment tank, the liquid inlet hole is open, and the oil drain hole and the at least one water drain hole are closed. When the pressure in the chamber is higher than the pressure outside of the treatment tank, the liquid inlet hole is closed, and the oil drain hole and the at least one water drain hole are open. Thus, it is assured that the to-be-treated floating oil and seawater can be guided into the chamber, and the separated floating oil and the seawater can be discharged without flowing in the reverse direction.

In an example, the treatment tank is provided with a baffle protruding radially outward from a periphery of the treatment tank. Thus, the baffle may sink into the seawater to provide a resistance resisting the floating force, thereby assuring that the floating member is able to move axially relative to the body.

In an example, the baffle is bowl-shaped and has an opening facing a top portion of the treatment tank. Thus, when the floating member is pushed by the sea wave to move upward in the axial direction relative to the body, the baffle may provide a resistance to resist the floating force to thereby stop the treatment tank from moving upward. This assures that the floating member is able to move axially relative to the body.

In an example, a bottom portion of the baffle is bowl-shaped and has an opening facing a bottom portion of the treatment tank. Thus, the baffle may provide a greater resistance to resist the floating force.

In an example, the treatment tank is provided with a weight connected to the treatment tank by a connecting member. Thus, the treatment tank may have a greater resistance to resist the floating force of the seawater.

In an example, the storage tank includes a pressure release hole in a position as high as or higher than a top portion of the treatment tank. Thus, the pressure in the storage tank may be discharged via the pressure release hole, such that the separated oil may enter the storage tank smoothly.

In an example, the storage tank includes a liquid drain valve configured to permit removal of the oil collected in the storage tank via the liquid drain valve. Thus, the storage tank may be used repeatedly.

In an example, the oil removal device further comprises a liquid collection tank. The liquid collection tank includes an annular wall having a plurality of slots intercommunicating with an outside of the liquid collection tank and a collecting portion at an inner side of the annular wall. The collecting portion intercommunicates with the liquid inlet hole of the treatment tank. Thus, the floating oil floating on the liquid surface may enter the collecting portion via the plurality of slots, and the annular wall having the plurality of slots may be used to avoid sundries from entering the collecting portion.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an exploded and partly-cutaway perspective view of an oil removal device of a first embodiment according to the present invention.

FIG. 2 is a cross sectional view of the oil removal device of the first embodiment according to the present invention.

FIG. 3 is an enlarged view of a circled portion A of FIG. 2.

FIG. 4 is a view similar to FIG. 3, illustrating operation of a treatment tank.

FIG. 5 is a cross sectional view illustrating an operation of the treatment tank of the oil removal device of FIG. 2.

FIG. 6 is a cross sectional view illustrating another operation of the treatment tank of the oil removal device of FIG. 2.

FIG. 7 is a cross sectional view illustrating a treatment tank of a second embodiment according to the present invention.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

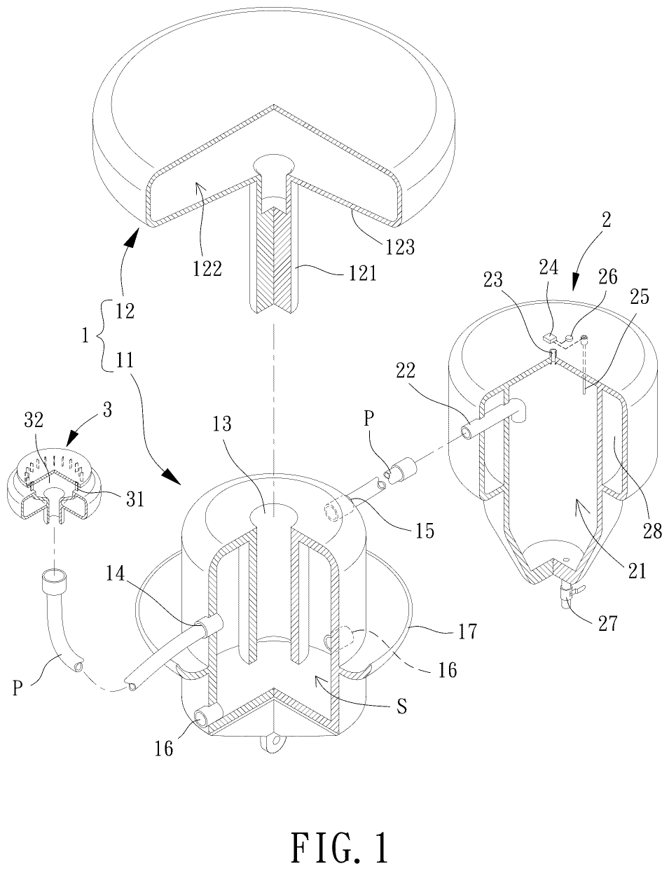

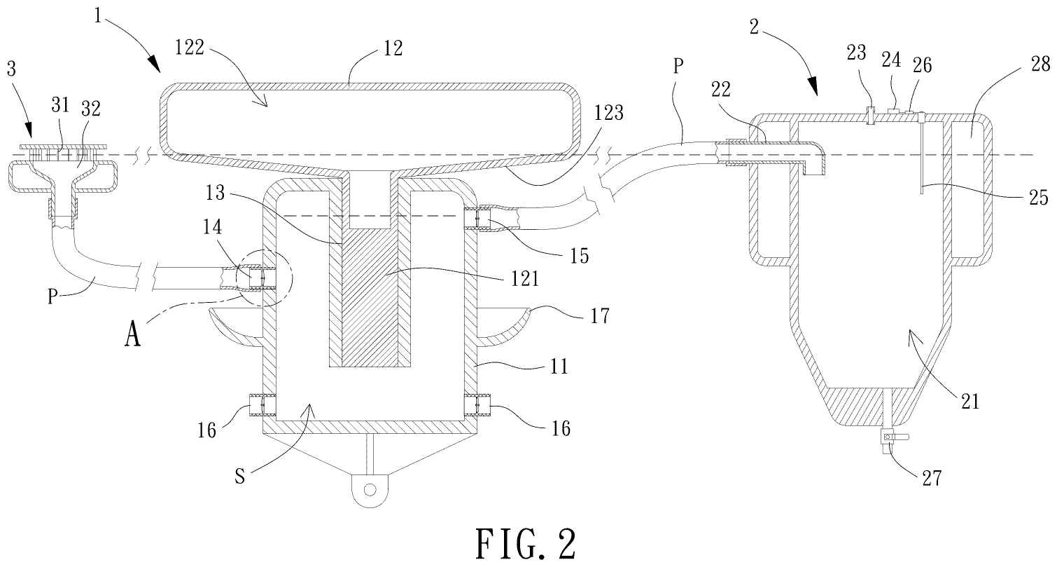

With reference to FIGS. 1-6, an oil removal device of a first embodiment according to the present invention includes a treatment tank 1 and a storage tank 2. The treatment tank 1 includes a body 11 and a floating member 12. The body 11 includes a shaft receiving hole 13 for receiving a shaft 121 of the floating member 12, such that the floating member 12 may move axially relative to the body 11. The specific gravity of floating member 12 is smaller than that of the seawater. Preferably, the floating member 12 includes an air chamber 122 and a bottom face 123. An area of the bottom face 123 is greater than an area of a top face of the body 11, such that the bottom face 123 of the floating member 12 may remain in contact with the sea surface. More preferably, the bottom face 123 is conic. As shown in FIG. 2, in the vertical direction, a periphery of the bottom face 123 is higher than a top portion of the shaft 121, such that the sea wave may push the bottom face 123, and the floating member 12 may move axially relative to the body 11. Thus, the shaft 121 and the shaft receiving hole 13 may provide functions of sucking liquid and discharging liquid as a pump.

The treatment tank 1 includes a chamber S intercommunicating with the shaft receiving hole 13. The chamber S includes a liquid inlet hole 14, an oil drain hole 15, and at least one water drain hole 16. According to the form shown, the oil drain hole 15 is in a position higher than the liquid inlet hole 14, and the at least one water drain hole 16 is in a position lower than the liquid inlet hole 14. The liquid inlet hole 14 may be used to guide the to-be-treated floating oil and seawater into the chamber S. After the to-be-treated floating oil and seawater enter the chamber S, since the specific gravity of the floating oil is smaller than that of the seawater, the floating oil may be discharged via the oil drain hole 15, and the seawater may be discharged via the at least one water discharge hole 16.

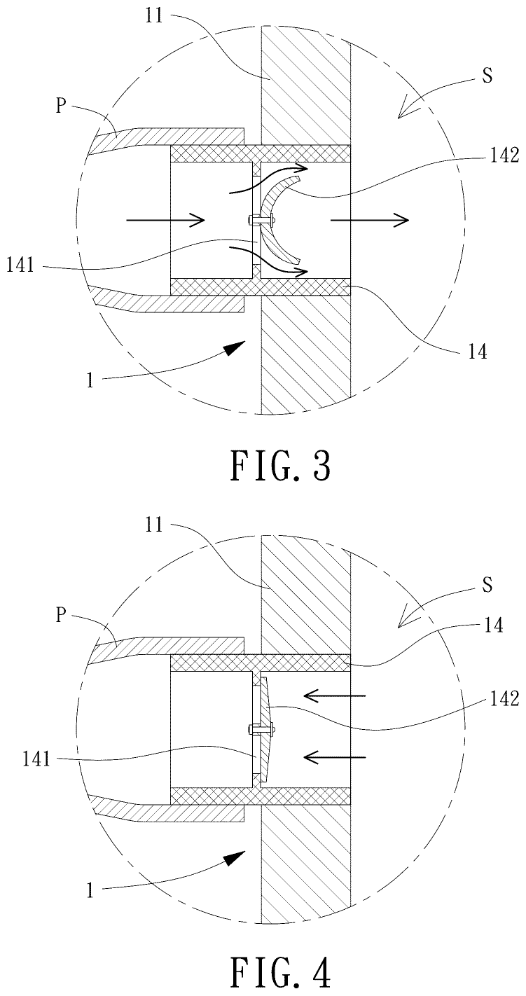

Each of the liquid inlet hole 14, the oil drain hole 15, and the at least one water drain hole 16 is provided with a one-way valve. When a pressure in the chamber S is lower than a pressure outside of the treatment tank 1, the liquid inlet hole 14 is open, and the oil drain hole 15 and the at least one water drain hole 16 are closed. When the pressure in the chamber S is higher than the pressure outside of the treatment tank 1, the liquid inlet hole 14 is closed, and the oil drain hole 15 and the at least one water drain hole 16 are open. With reference to FIGS. 3 and 4, taking the liquid inlet hole 14 as an example, the liquid inlet hole 14 includes a valve hole 141 and a valve plate 142 which may cover the valve hole 141. When the pressure in the chamber S is lower than the pressure outside of the treatment tank 1, the floating oil floating on the sea surface and the seawater enter the chamber S via the liquid inlet hole 14. When the pressure in the chamber S is higher than the pressure outside of the treatment tank 1, the valve plate 142 covers the valve hole 141 to close the liquid inlet hole 14. Thus, the floating oil floating on the sea surface and the seawater cannot enter the chamber S via the liquid inlet hole 14. Likewise, the oil drain hole 15 and the at least one water drain hole 16 are open when the pressure in the chamber S is higher than the pressure outside of the treatment tank 1, and that when the pressure in the chamber S is lower than the pressure outside of the treatment tank 1, the liquid inlet hole 14 is open, whereas the oil drain hole 15 and the at least one water drain hole 16 are closed, which can be appreciated by a person having ordinary skill in the art, and detailed description is not set forth to avoid redundancy.

Preferably, the treatment tank 1 may be provided with a baffle 17 protruding radially outward from a periphery of the treatment tank 1. The baffle 17 may sink into the seawater. Thus, when the sea wave pushes the bottom face 123 of the floating member 12 upward, the floating member 12 may move upward in the axial direction relative to the body 11, whereas the baffle 17 sinking into the seawater may provide a resistance to resist the floating force, thereby stopping the treatment tank 1 from moving upward. This assures that the floating member 12 is able to move axially relative to the body 11. Preferably, the baffle 17 is bowl-shaped and has an opening facing the top portion of the treatment tank 1. Therefore, a greater resistance is provided to stop the treatment tank 1 from moving upward.

The storage tank 2 includes a storage space 21 intercommunicating with the oil drain hole 15 of the treatment tank 1, such that the separated oil in the treatment tank 1 may enter the storage space 21. In this embodiment, the storage tank 2 is provided with a guiding tube 22 to intercommunicate the storage space 21 and the outside of the treatment tank 1. Furthermore, the guiding tube 22 is connected to an end of a connecting tube P, such that the separated oil in the treatment tank 2 may enter the storage space 21 of the storage tank 2 via the guiding tube 22. Preferably, the storage tank 2 includes a pressure release hole 23 in a position as high as or higher than a top portion of the treatment tank 1, such that the pressure in the storage tank 2 may be released via the pressure release hole 23. Furthermore, the storage tank 2 may be provided with a control module 24 coupled with a liquid level sensor 25 and a locating unit 26. The liquid level sensor 25 is disposed in the storage space 21 and is configured to detect the amount of oil stored in the storage space 21 and to generate an oil quantity information which is transmitted back to the control module 24. The locating unit 26 may be a conventional GPS device and is configured to generate a location coordinate which is sent back to the control module 24. The control module 24 may determine whether the oil stored in the storage space 21 reaches a predetermined amount according to the oil quantity information. If yes, the control module 24 sends out a signal including the location coordinate to a manager, and the manager may head to the location coordinate to retrieve the storage tank 2.

The storage tank 2 may further include a liquid drain valve 27. When the manager retrieves the storage tank 2, the oil collected in the storage tank 2 may be removed via the liquid drain valve 27, such that the storage tank 2 may be used repeatedly. Preferably, the storage tank 2 may further include an air chamber 28 to provide the storage tank 2 with a greater floating force to always float on the sea surface.

The oil removal device according to the present invention may further include a liquid collection tank 3. The liquid collection tank 3 includes an annular wall having a plurality of slots 31 intercommunicating with an outside of the liquid collection tank 3 and a collecting portion 32 at an inner side of the annular wall. The plurality of slots 31 may face the sea surface, such that the liquid collection tank 3 may collect the floating oil floating on the sea surface via the plurality of slots 31. The floating oil may enter the collecting portion 32 via the plurality of slots 31, and the annular wall having the plurality of slots 31 may be used to prevent sundries from entering the collecting portion 32. The collecting portion 32 is connected to the liquid inlet hole 14 of the treatment tank 1 by the connecting tube P.

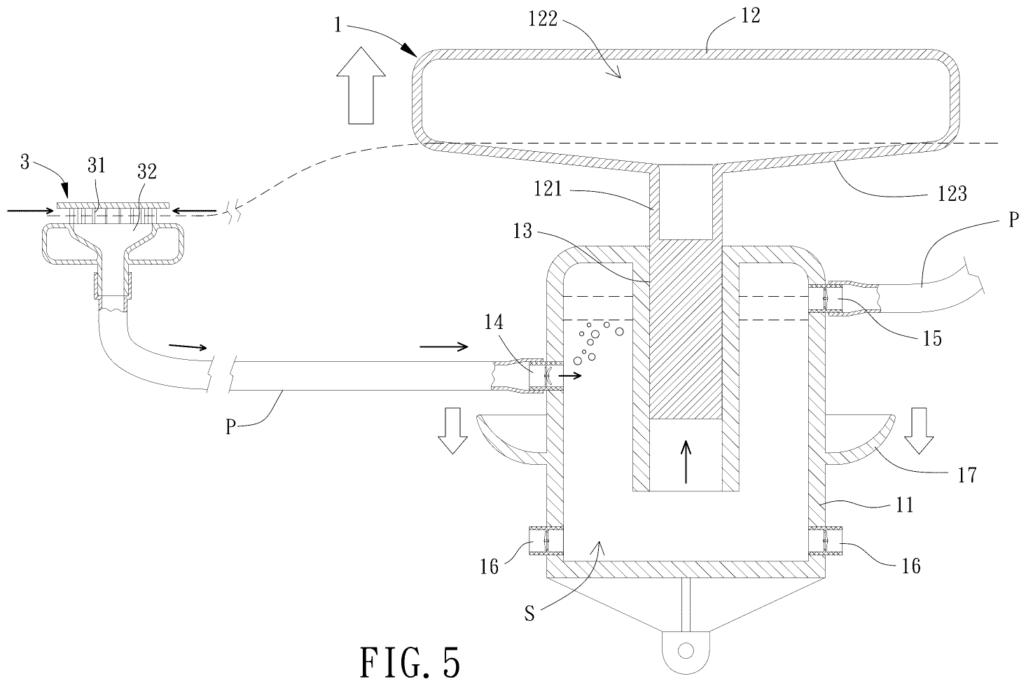

With reference to FIG. 5, in use of the oil removal device of the first embodiment according to the present invention, the liquid collection tank 3 is connected with the liquid inlet hole 14 of the treatment tank 1 via the connecting tube P, such that the liquid collection tank 3 and the treatment tank 1 may have a distance therebetween. When the wave pushes the bottom face 123 of the floating member 2 upward, the floating member 12 moves upward in the axial direction relative to the body 11. Thus, the shaft 121 moves upward relative to the shaft receiving hole 13 to provide a liquid suction action of a pump. At this time, the liquid inlet hole 14 is open, whereas the oil drain hole 15 and the at least one water drain hole 16 are closed. Therefore, the floating oil collected by the liquid collection tank 3 may enter the chamber S of the treatment tank 1 via the connecting tube P and the liquid inlet hole 14. Due to the different specific gravities of the oil and seawater, the floating oil in the chamber S will float on top of the seawater.

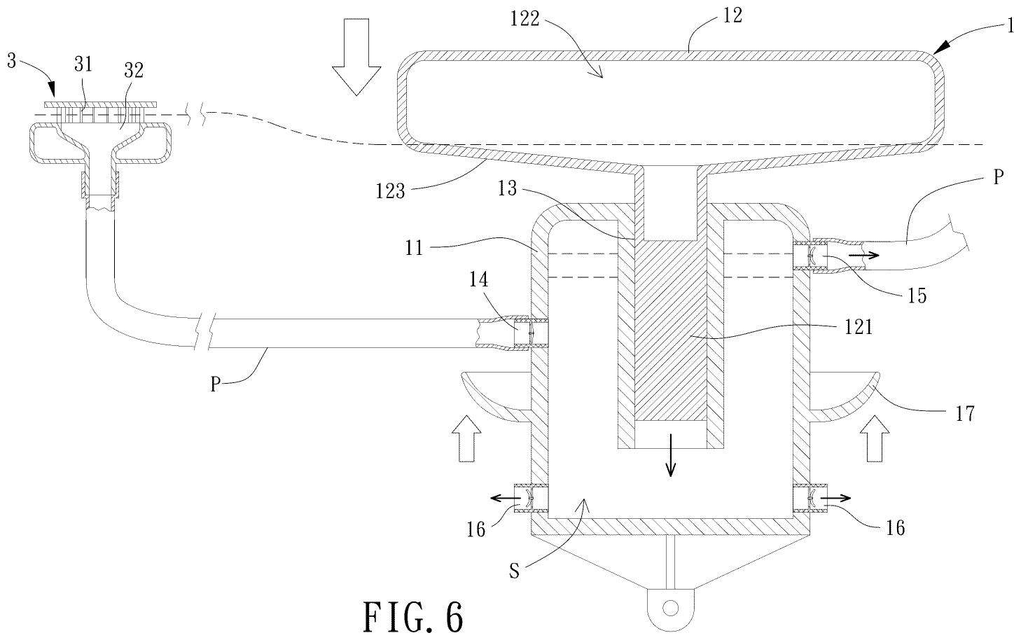

With reference to FIG. 6, when the wave moves downward, the floating member 12 moves downward together with the wave, and the treatment tank 1 is provided with a resistance to resist the floating force due to the baffle 17 sinking into the sea water. Thus, the treatment tank 1 will not synchronously move downward by a displacement equal to that of the wave, whereas the shaft 121 of the floating member 12 may move downward in the axial direction relative to the shaft receiving hole 13 of the body 11. At this time, the shaft 121 provides a liquid discharging action of a pump to force the floating oil at the upper portion of the chamber S to be discharged via the oil drain hole 15 and then enter the storage space 21 of the storage tank 2 via the connecting tube P and the guiding tube 22. Furthermore, the seawater at the lower portion of the chamber S is discharged back into the sea via the at least one water drain hole 16. Therefore, plural oil removal devices according to the present invention may be disposed in the ocean to collect the floating oil floating on the sea surface through use of the energy of waves.

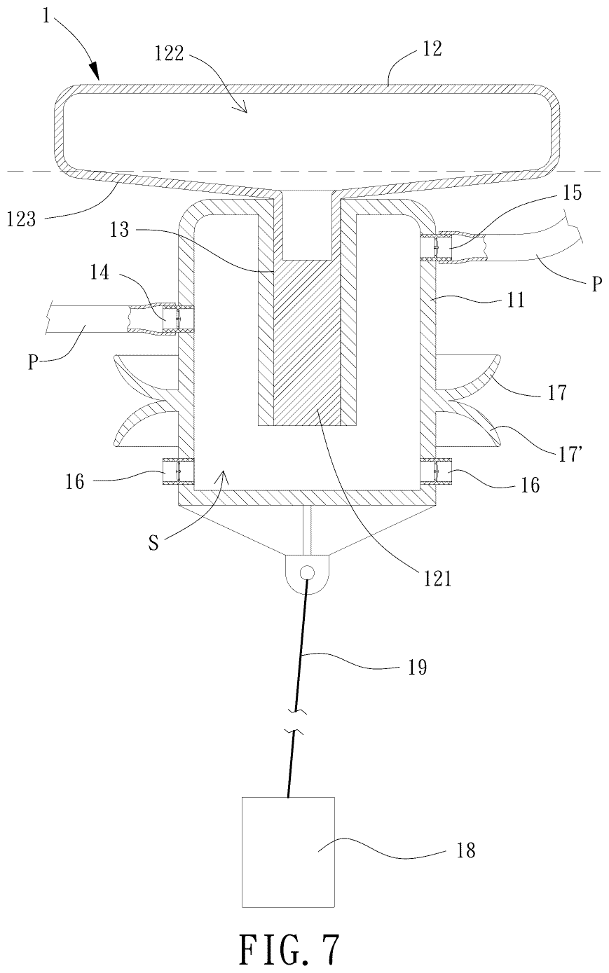

FIG. 7 shows an oil removal device of a second embodiment according to the present invention. In comparison with the first embodiment, this embodiment may provide the treatment tank 1 immersed in the seawater with a greater resistance to resist the floating force. The treatment tank 1 is further provided with a weight 18 which may be connected to the treatment tank 1 by a connecting member 19, such that the treatment tank 1 may have a greater resistance to resist the floating force of the seawater. Furthermore, aside from the top portion having an opening facing the top portion of the treatment tank 1, the bottom portion of the baffle 17′ may also be bowl-shaped and have an opening facing a bottom portion of the treatment tank 1. Therefore, the baffle 17′ may also provide a resistance, such that when the treatment tank 1 moves downward together with the wave, the baffle 17′ may prevent the treatment tank 1 from sinking excessively into the seawater. Thus, it can be assured that the shaft 121 of the floating member 11 is able to move downward in the axial direction relative to the shaft receiving hole 13 of the body 11, thereby providing a liquid discharging action of a pump.

In view of the foregoing, the oil removal devices according to the present invention may be disposed widely on the sea to widely collect the floating oil floating on the sea. Furthermore, the treatment tank may fully use the energy of the sea waves to separate the oil from the seawater in the treatment tank, and the separated oil may be delivered to and stored in the storage space of the storage tank. The control module may determine whether the oil stored in the storage space reaches a predetermined amount according to the oil quantity information. If yes, the control module sends out a signal including the location coordinate to a manager, and the manager may head to the location coordinate to retrieve the storage tank. Accordingly, the floating oil floating on the sea surface may be collected to avoid spreading of the floating oil, thereby reducing impact on the marine ecosystem.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. An oil removal device comprising:
a treatment tank including a body and a floating member, wherein the body includes a shaft receiving hole receiving a shaft of the floating member and permitting axial movement of the shaft, wherein the treatment tank includes a chamber intercommunicating with the shaft receiving hole, and wherein the chamber includes a liquid inlet hole, an oil drain hole, and at least one water drain hole; and
a storage tank including a storage space intercommunicating with the oil drain hole of the treatment tank, wherein the storage tank is provided with a control module coupled with a liquid level sensor and a locating unit, wherein the liquid level sensor is configured to detect an amount of oil stored in the storage space and to generate an oil quantity information which is transmitted back to the control module, and wherein the locating unit is configured to generate a location coordinate which is sent back to the control module.

2. The oil removal device as claimed in claim 1, wherein the floating member includes an air chamber and a bottom face having an area greater than an area of a top face of the body.

3. The oil removal device as claimed in claim 2, wherein the bottom face is conic and has a periphery higher than a top portion of the shaft.

4. The oil removal device as claimed in claim 1, wherein the oil drain hole is in a position higher than the liquid inlet hole, and wherein the at least one water drain hole is in a position lower than the liquid inlet hole.

5. The oil removal device as claimed in claim 1, wherein each of the liquid inlet hole, the oil drain hole, and the at least one water drain hole is provided with a one-way valve, wherein when a pressure in the chamber is lower than a pressure outside of the treatment tank, the liquid inlet hole is open, and the oil drain hole and the at least one water drain hole are closed, and wherein when the pressure in the chamber is higher than the pressure outside of the treatment tank, the liquid inlet hole is closed, and the oil drain hole and the at least one water drain hole are open.

6. The oil removal device as claimed in claim 1, wherein the treatment tank is provided with a baffle protruding radially outward from a periphery of the treatment tank.

7. The oil removal device as claimed in claim 6, wherein the baffle is bowl-shaped and has an opening facing a top portion of the treatment tank.

8. The oil removal device as claimed in claim 7, wherein a bottom portion of the baffle is bowl-shaped and has an opening facing a bottom portion of the treatment tank.

9. The oil removal device as claimed in claim 1, wherein the treatment tank is provided with a weight connected to the treatment tank by a connecting member.

10. The oil removal device as claimed in claim 1, wherein the storage tank includes a pressure release hole in a position as high as or higher than a top portion of the treatment tank.

11. The oil removal device as claimed in claim 1, wherein the storage tank includes a liquid drain valve configured to permit removal of the oil collected in the storage tank via the liquid drain valve.

12. The oil removal device as claimed in claim 1, further comprising a liquid collection tank, wherein the liquid collection tank includes an annular wall having a plurality of slots intercommunicating with an outside of the liquid collection tank and a collecting portion at an inner side of the annular wall, and wherein the collecting portion intercommunicates with the liquid inlet hole of the treatment tank.
